(19) United States
(12) Patent Application Publication
(10) Pub. No.: US 2006/0209459 A1
(43) Pub. Date: Sep. 21, 2006

(54) Perpendicular magnetic recording head and recording medium for recording data using the same

(75) Inventors: Young-hun Im, Suwon-si (KR); Yong-su Kim, Seoul (KR); Hoon-sang Oh, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/378,354

(22) Filed: Mar. 20, 2006

(30) Foreign Application Priority Data
Mar. 18, 2005 (KR) 2005-0022677

(51) Int. Cl. G11B 5/147

(52) U.S. Cl. 360/126

(57) ABSTRACT

A perpendicular magnetic recording head and a recording medium for recording data using the same. The perpendicular magnetic recording head includes: a main pole whose lower end has a predetermined width t1; a return pole whose upper end is connected to the main pole and whose lower end is separated from the lower end of the main pole by a predetermined gap g 1; a sub yoke whose lower end is recessed by a predetermined depth d1 in the upward direction from the lower end of the main pole; a coil wrapped around the main pole and the sub yoke; magnetic shield layers; and a reading device located between the magnetic shield layers, wherein a ratio (d1/t1) of the recess depth d1 to the width t1 is less than or equal to 6.

### CROSS-REFERENCE TO RELATED PATENT APPLICATION

This application claims priority from Korean Patent Application No. 10-2005-0022677, filed on Mar. 18, 2005, in the Korean Intellectual Property Office, the disclosure of which is incorporated herein in its entirety by reference.

### BACKGROUND OF THE INVENTION

1. Field of the Invention

The present invention relates to a magnetic recording head and, more particularly, to a perpendicular magnetic recording head and a recording medium for recording data using the same.

2. Description of the Related Art

The popularization of the Internet has led to a rapid increase of information exchange between individuals and/or organizations. Thus, users are interested in computers with high data processing speed and data storage capacity.

Thus, CPU chips and computer peripherals have been improved to increase the data processing speed of computers, and various types of recording media, for instance, hard disks have been introduced to enlarge the data storage capacity.

Although recording media using a strong dielectric layer as a data recording layer has been recently introduced, most recording media still use a magnetic layer as a data recording layer.

A data recording method for recording magnetic media is largely divided into a horizontal magnetic recording method and a perpendicular magnetic recording method.

The former is a method of recording data using a magnetic layer with magnetic polarization horizontally arranged on the surface thereof, and the latter is a method of recording data using a magnetic layer with magnetic polarization perpendicularly arranged on the surface thereof.

Considering data recording density, the perpendicular magnetic recording method is better than the horizontal magnetic recording method.

A process of recording data on a magnetic layer can be considered as an interaction between the magnetic layer and a magnetic head. Thus, to record data on a magnetic layer with high density, improvement of both the magnetic head and the magnetic layer is required.

Recently, as the perpendicular magnetic recording method has drawn more attention along with the development of information technology, various types of magnetic heads compatible with the perpendicular magnetic recording method have been introduced.

Conventional magnetic heads for implementing the perpendicular magnetic recording method generally include a main pole and a return pole, in order to record data on a magnetic layer, and a magneto-resistive (MR) device to read data recorded on the magnetic layer.

If the track density of the magnetic layer is high when the perpendicular magnetic recording method is used, data recording density of the magnetic layer can be further increased. An increase of the track density of the magnetic layer causes a decrease of a track pitch. Thus, it is necessary that the size of the conventional magnetic head is reduced proportionally to the decrease of the track pitch, and the size of the conventional magnetic head is actually decreasing when the track pitch is decreased.

However, the conventional magnetic head generates a high leakage magnetic flux in the track direction according to a skew angle. Due to this, in a process of recording data on a selected track of the magnetic layer using the conventional magnetic head, undesired data can be recorded on unselected tracks.

### SUMMARY OF THE INVENTION

The present invention provides a perpendicular magnetic recording head that minimizes a skew angle effect to prevent or minimize a magnetic flux leakage in a process of recording data on a high-density perpendicular magnetic recording medium.

The present invention also provides a recording medium having a factor that can improve characteristics of the perpendicular magnetic recording head.

According to an aspect of the present invention, there is provided a perpendicular magnetic recording head comprising: a main pole having a lower end having a width t1, a return pole having an upper end and a lower end, the upper end being connected to the main pole, the lower end of the return pole being separated from the lower end of the main pole by a gap g1; a sub yoke having a lower end, the lower end being recessed by a depth d1 in the upward direction from the lower end of the main pole, and a coil wrapped around the main pole and the sub yoke; wherein a ratio (d1/t1) of the depth d1 to the width t1 is less than or equal to 6.

A ratio (g1/t1) of the gap g1 to the width t1 may be less than or equal to 0.3. The width t1 may satisfy the following formula: t2/t1≦0.3, wherein t2 is the thickness of a first magnetic layer in a recording medium in which the first magnetic layer, an intermediate layer, and a second magnetic layer for recording data thereon are sequentially layered.

The gap g1 may satisfy the following formula: t2/g1≦0.6, wherein t2 is the thickness of a first magnetic layer in a recording medium in which the first magnetic layer, an intermediate layer, and a second magnetic layer that record data thereon are sequentially layered.

According to another aspect of the present invention, there is provided a perpendicular magnetic recording head comprising: a main pole having a lower end, the lower end having a width t1, a return pole having an upper end and a lower end, the upper end being connected to the main pole, the lower end of the return pole being separated from the lower end of the main pole by a gap g1, a sub yoke having a lower end, the lower end being recessed by a depth d1 in an upward direction from the lower end of the main pole, and a coil wrapped around the main pole and the sub yoke; wherein the width t1 satisfies the following formula: t2/t1≦0.3, wherein t2 is a thickness of a first magnetic layer in a recording medium in which the first magnetic layer, an intermediate layer, and a second magnetic layer that record data thereon, are sequentially layered.

A ratio (t2/g1) of the thickness t2 to the gap g1 may be less than or equal to 0.6. A ratio (g1/t1) of the gap g1 to the width t1 may be less than or equal to 0.3.

According to another aspect of the present invention, there is provided a recording medium on which data is recorded using a perpendicular magnetic recording head having a main pole and a return pole, the medium comprising: a first magnetic layer; an intermediate layer formed on the first magnetic layer; and a second magnetic layer on which data is recorded, formed on the intermediate layer, wherein the thickness t2 of the first magnetic layer satisfies the following formula: t2/t1≦0.3, wherein t1 is the width of the lower end of the main pole.

The thickness t2 may satisfy the following formula: t2/g1≦0.6, wherein g1 is a gap between the lower end of the main pole and the lower end of the return pole.

According to an aspect of the present invention, a magnetic field gradient between a main pole and a return pole is much greater compared to the prior art. Thus, by using a perpendicular magnetic recording head according to the present invention, magnetic flux leakage due to a skew angle effect can be prevented or minimized. Accordingly, data can be recorded properly only on a selected track of a recording medium, and even if data is recorded on unselected tracks, this effect can be minimized.

### BRIEF DESCRIPTION OF THE DRAWINGS

The above and other features and advantages of the present invention will become more apparent by describing in detail exemplary embodiments thereof with reference to the attached drawings in which:

FIG. 1 is a sectional plan view of a core part of a perpendicular magnetic recording head according to an exemplary embodiment of the present invention; and

FIGS. 2 through 4 are graphs illustrating simulated results for the variation of the gradient of a magnetic field generated by a main pole according to specifications of the perpendicular magnetic recording head illustrated in FIG. 1.

### DETAILED DESCRIPTION OF THE INVENTION

A perpendicular magnetic recording head (hereinafter, a magnetic head) according to an exemplary embodiment of the present invention will now be described more fully with reference to the accompanying drawings. The thickness of layers or areas is exaggerated for clearness of the specification.

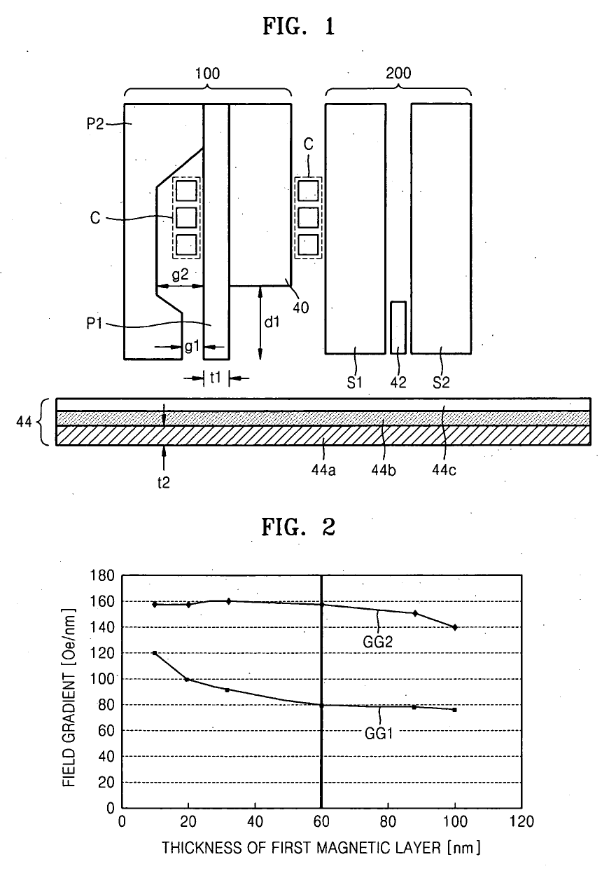

FIG. 1 is a sectional plan view of a core part of a magnetic head and a recording medium 44 according to an embodiment of the present invention.

Referring to FIG. 1, the magnetic head includes a recording module 100 used to record data on the recording medium 44 and a reading module 200 used to read data recorded on the recording medium 44.

The recording module 100 includes a main pole P1, a return pole P2, a sub yoke 40, and a coil C. The return pole P2 and the sub yoke 40 may be made of the same material, for instance, NiFe, but in different compositions ratios for different coercive forces Bs. The main pole P1 may be, for example, made of NiFe, NiFeTa, CoFe, or CoFeTa. The main pole P1 and the return pole P2 are directly used to record data on the recording medium 44. The sub yoke 40 focuses a magnetic field generated in a process of recording data on a selected area of the recording medium 44. The main pole P1 has a predetermined width t1. The return pole P2 is located at one side of the main pole P1, and the sub yoke 40 is located at the other side of the main pole P1. The sub yoke 40 is attached to the main pole P1. The sub yoke 40 is recessed by a predetermined depth d1 in the upward direction from the lower end of the main pole P1. That is, the lower end of the sub yoke 40 is located at an upward position than the lower end of the main pole P1. Thus, a difference in elevation between the lower end of the sub yoke 40 and the lower end of the main pole P1 corresponds to the recess depth d1.

The coil C is wrapped around the main pole P1 and the sub yoke 40. A gap g1 exists between the lower end of the main pole P1 and the lower end of the return pole P2. The gap g1 extends to the lower intermediate portion of the main pole P1 and the lower intermediate portion of the return pole P2, and a much wider gap g2 than g1 exists between the intermediate parts of the main pole P1 and the return pole P2, extending from the lower intermediate portion toward the upper portions of poles P1 and P2. The coil C passes through the gap g2 between the intermediate parts of the main pole P1 and the return pole P2. The upper ends of the main pole P1 and the return pole P2 are connected.

It is preferable that the width t1 of the main pole P1, the recess depth d1 of the sub yoke 40, and the gap g1 between the lower ends of the main pole P1 and the return pole P2 have values that optimize a magnetic field gradient generated by the main pole P1 so as to prevent undesired data from being recorded on unselected tracks in a process of recording data on the recording medium 44. Formulas (1) and (2) show the relationships between the width t1 of the main pole P1, the recess depth d1 of the sub yoke 40, and the gap g1 between the lower ends of the main pole P1 and the return pole P2.
d1/t1≦6 (1)
g1/t1≦0.3 (2)

When data is recorded on the recording medium 44, a recording magnetic field is generated between the lower ends of the main pole P1 and the return pole P2. The recording magnetic field begins from the lower end of the main pole P1, passes through a second magnetic layer 44c and an intermediate layer 44b of the recording medium 44, arrives below the return pole P2 along a first magnetic layer 44a of the recording medium 44, passes through the intermediate layer 44b and the second magnetic layer 44c, and arrives at the lower end of the return pole P2.

The reading module 200 is adjacent to the recording module 100, and a portion of the coil C passes therebetween. The reading module 200 includes first and second magnetic shield layers S1 and S2 and a reading device 42 between the first and second magnetic shield layers S1 and S2. The first and second magnetic shield layers S1 and S2 prevent magnetic fields generated by magnetic elements around a predetermined location of a selected track from reaching the predetermined location while data is being read from the predetermined location. The reading device 42, for example, can be a giant magneto-resistive (GMR) device or a tunneling magneto-resistive (TMR) device.

A process of recording data on the recording medium 44 and a process of reading data from the recording medium 44 can be considered as interactions between the magnetic head and the recording medium 44 using magnetic fields. The recording medium 44 includes the intermediate layer 44b, the second magnetic layer 44c is disposed on the intermediate layer 44b for recoding data, and the first magnetic layer 44a made of a soft magnetic material below the intermediate layer 44b. That is, the recording medium 44 includes the first and second magnetic layers 44a and 44c, and when data is recorded on the recording medium 44, the magnetic field generated by the main pole P1 passes through the first and second magnetic layers 44a and 44c of the recording medium 44. Thus, the thickness of components of the recording medium 44, particularly the thickness t2 of the first magnetic layer 44a, can affect the magnetic field generated by the main pole P1 in a data recording process together with the width t1 of the main pole P1 and the gap g1 between the lower ends of the main pole P1 and the return pole P2.

In this exemplary embodiment, the thickness t2 of the first magnetic layer 44a, the width t1 of the main pole P1, and the gap g1 between the lower ends of the main pole P1 and the return pole P2 have values satisfying the following Formulas (3) and (4) in order to optimize the gradient of the magnetic field generated by the main pole P1 so as to minimize or prevent undesired data from being recorded on unselected tracks of the recording medium 44 in a data recording process.
t2/t1≦0.3 (3)
t2/g1≦0.6 (4)

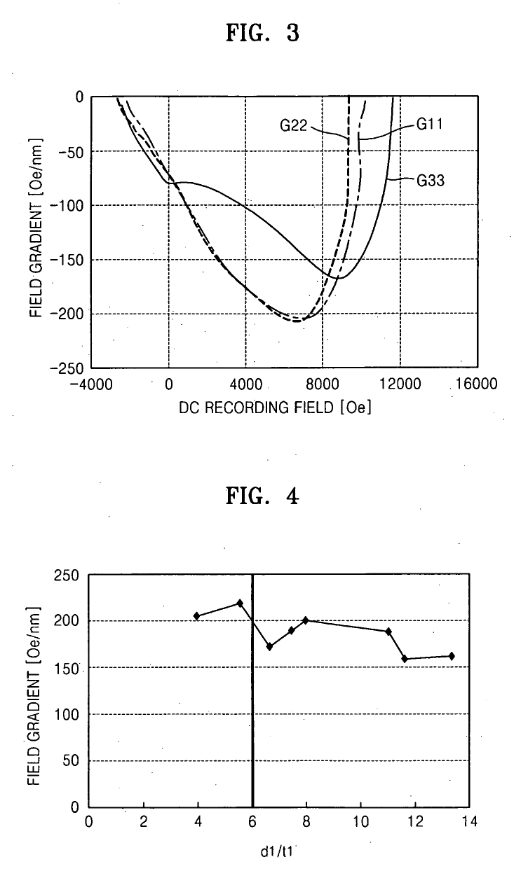

Simulations regarding the effect obtained by changing field gradient generated by the main pole P1 due to the width t1 of the main pole P1, the recess depth d1 of the sub yoke 40, the gap g1 between the lower ends of the main pole P1 and the return pole P2, and the thickness t2 of the first magnetic layer 44a in a process of recording data on the recording medium 44 are shown in FIGS. 2 through 4.

FIG. 2 illustrates results of simulations performed when only the gap g1 between the lower ends of the main pole P1 of the magnetic head and the return pole P2 and the thickness t2 of the first magnetic layer 44a of the recording medium 44 were changed, and the values of the other components of the magnetic head and the other components of the recording medium 44 were fixed to predetermined values. Referring to FIG. 2, a first graph GG1 illustrates a simulation result of the variation of the magnetic field gradient when varying the thickness t2 of the first magnetic layer 44a when the gap g1 between the lower ends of the main pole P1 of the magnetic head and the return pole P2 is 40 nm, and a second graph GG2 illustrates a simulation result when the gap g1 is 100 nm.

Comparing the first and second graphs GG1 and GG2 of FIG. 2, the recording magnetic field gradient is smaller when the gap g1 is 40 nm than when the gap g1 is 100 nm in a state where the thickness t2 of the first magnetic layer 44a of the recording medium 44 is below 60 nm. When the thickness t2 of the first magnetic layer 44a is below 60 nm, and when the gap g1 is 100 nm, a ratio (t2/g1) of the thickness t2 of the first magnetic layer 44a to the gap g1 is below 0.6 (60 nm/100 nm), satisfying Formula (4).

The results of FIG. 2 show that the recording magnetic field gradient is greater when the correlation between the thickness t2 of the first magnetic layer 44a and the gap g1 between the lower ends of the main pole P1 and the return pole P2 satisfies Formula (4) than when the correlation between the thickness t2 and the gap g1 does not satisfy Formula (4).

Thus, when the gap g1 of the magnetic head satisfies Formula (4), and when the recording medium 44 satisfies Formula (4), if data is recorded on a selected track of the recording medium 44 using the magnetic head, the undesired data recording on unselected tracks of the recording medium 44 can be prevented or minimized.

FIG. 3 illustrates results of simulations when only the gap g1 between the lower ends of the main pole P1 of the magnetic head and the return pole P2, and the width t1 of the main pole P1 were changed, while the values of the other components of the magnetic head and the components of the recording medium 44 were fixed to predetermined values.

Referring to FIG. 3, a first graph G11 illustrates a simulation result when a ratio (g1/t1) of the gap g1 between the lower ends of the main pole P1 of the magnetic head and the return pole P2, to the width t1 of the main pole P1, is 0.16. A second graph G22 illustrates a simulation result when the ratio (g1/t1) is 0.2, and a third graph G33 illustrates a simulation result when the ratio (g1/t1) is 0.4.

The strength of the magnetic field generated by the main pole P1 in a process of recording data on the recording medium 44 is 0.8˜1.4 teslas (T). Comparing the first through third graphs G11, G22, and G33 to each other, when the coercivity of second magnetic layer 44c is 4,000˜5,000 oersteds (Oe), the gradient of the magnetic field generated by the main pole P1 when the ratio (g1/t1) is 0.16 is almost the same as the field gradient when the ratio (g1/t1) is 0.2, and much greater than the field gradient when the ratio (g1/t1) is 0.4. The results of FIG. 3 show that the field gradient generated by the lower end of the main pole P1 in a data recording process can be improved if the gap g1 between the lower ends of the main pole P1 of the magnetic head and the return pole P2 and the width t1 of the main pole P1 satisfy Formula (2).

Thus, when the magnetic head has a structure in which the width t1, the recess depth d1, and the gap g1 satisfy Formula (2), desired data can be recorded effectively on a selected track of the recording medium 44 using the magnetic head, and undesired data recorded on unselected tracks can be minimized or prevented.

FIG. 4 illustrates a result of a simulation performed to measure the variation of the recording magnetic field gradient when only the width t1 of the main pole P1 of the magnetic head and the depth d1 of the sub yoke 40 were changed, while the values of the other components of the magnetic head and the components of the recording medium 44 were fixed to predetermined values. The horizontal axis of FIG. 4 indicates a ratio (d1/t1) of depth d1 of the sub yoke 40 to the width t1 of the main pole P1.

Referring to the graph of FIG. 4, the magnetic field gradient when the ratio (d1/t1) is below 6 is greater than the magnetic field gradient when the ratio (d1/t1) is over 6. This result shows that the undesired recording of data on unselected tracks can be prevented or minimized even when the magnetic head has a structure in which the width t1, the recess depth d1, and the gap g1 satisfy only Formula (1).

Considering the results described above, although a simulation on Formula (3) has not been performed, it will be understood that there is a high probability that the desired data can be recorded only on a selected track of the recording medium 44 using the magnetic head having the structure in which the above variables satisfy Formula (3).

As described above, since the recording magnetic field gradient can be increased by focusing the recording magnetic field on a selected track of a recording medium using a magnetic head according to exemplary embodiments of the present invention, the undesired recording of data on tracks other than the selected track due to a skew angle effect, can be prevented or minimized.

While this invention has been particularly shown and described with reference to exemplary embodiments, the above description should not be considered as limiting the present invention. For example, it will be understood by those skilled in the art that the values of the other components of the magnetic head can be changed when the gap g1 between the lower ends of the main pole P1 and the return pole P2, the recess depth d1 of the sub yoke 40, and the width t1 of the main pole P1 in the magnetic head of the present invention are fixed, or the values of the other components can be changed too. In addition, formulas similar to Formulas (1) through (4) can be analogized for a perpendicular magnetic recording head having a different structure from the magnetic head of the present invention illustrated in FIG. 1. In addition, the main pole P1, the return pole P2, and the sub yoke 40 can be made of magnetic materials different from NiFe, and the constant values in Formulas (1) through (4) can be changed. Therefore, the scope of the invention is defined not by the detailed description of the invention but by the appended claims, and all differences within the scope will be construed as being included in the present invention.

What is claimed is:

1. A perpendicular magnetic recording head comprising:
a main pole having a lower end, the lower end having a width t1;
a return pole having an upper end and a lower end, the upper end being connected to the main pole, the lower end of the return pole being separated from the lower end of the main pole by a gap g1;
a sub yoke having a lower end, the lower end being recessed by a depth d1 in an upward direction from the lower end of the main pole; and
a coil wrapped around the main pole and the sub yoke,
wherein a ratio (d1/t1) of the depth d1 to the width t1 is less than or equal to 6 (d1/t1≦6).

2. The perpendicular magnetic recording head of claim 1, wherein a ratio (g1/t1) of the gap g1 to the width t1 is less than or equal to 0.3 (g1/t1≦0.3).

3. The perpendicular magnetic recording head of claim 1, wherein the width t1 satisfies the following formula: t2/t1≦0.3, wherein t2 is a thickness of a first magnetic layer in a recording medium in which the first magnetic layer, an intermediate layer, and a second magnetic layer that record data thereon, are sequentially layered.

4. The perpendicular magnetic recording head of claim 1, wherein the gap g1 satisfies the following formula: t2/g1≦0.6, wherein t2 is a thickness of a first magnetic layer in a recording medium in which the first magnetic layer, an intermediate layer, and a second magnetic layer that record data thereon, are sequentially layered.

5. The perpendicular magnetic recording head of claim 3, wherein a ratio (t2/g1) of the thickness of the first magnetic layer t2 to the gap g1 is less than or equal to 0.6 (t2/g1≦0.6).

6. The perpendicular magnetic recording head of claim 2, wherein the width t1 satisfies the following formula: t2/t1≦0.3, wherein t2 is a thickness of a first magnetic layer in a recording medium in which the first magnetic layer, an intermediate layer, and a second magnetic layer that record data thereon, are sequentially layered.

7. The perpendicular magnetic recording head of claim 2, wherein the gap g1 satisfies the following formula: t2/g1≦0.6, wherein t2 is a thickness of a first magnetic layer in a recording medium in which the first magnetic layer, an intermediate layer, and a second magnetic layer that record data thereon, are sequentially layered.

8. A perpendicular magnetic recording head comprising:
a main pole having a lower end, the lower end having a width t1;
a return pole having an upper end and a lower end, the upper end being connected to the main pole, the lower end of the return pole being separated from the lower end of the main pole by a gap g1;
a sub yoke having a lower end, the lower end being recessed by a depth d1 in an upward direction from the lower end of the main pole; and
a coil wrapped around the main pole and the sub yoke,
wherein the width t1 satisfies the following formula: t2/t1≦0.3, wherein t2 is a thickness of a first magnetic layer in a recording medium in which the first magnetic layer, an intermediate layer, and a second magnetic layer that record data thereon, are sequentially layered.

9. The perpendicular magnetic recording head of claim 8, wherein a ratio (t2/g1) of the thickness t2 to the gap g1 is less than or equal to 0.6 (t2/g1≦0.6).

10. The perpendicular magnetic recording head of claim 8, wherein a ratio (g1/t1) of the gap g1 to the width t1 is less than or equal to 0.3 (g1/t1≦0.3).

11. The perpendicular magnetic recording head of claim 9, wherein a ratio (g1/t1) of the gap g1 to the width t1 is less than or equal to 0.3 (g1/t1≦0.3).

12. A recording medium on which data is recorded using a perpendicular magnetic recording head having a main pole and a return pole, the recording medium comprising:
a first magnetic layer;
an intermediate layer formed on the first magnetic layer; and
a second magnetic layer on which data is recorded, the second magnetic layer formed on the intermediate layer,
wherein a thickness t2 of the first magnetic layer satisfies the following formula: t2/t1≦0.3, wherein t1 is a width of a lower end of the main pole.

13. The medium of claim 12, wherein the thickness t2 satisfies the following formula: t2/g1≦0.6, wherein g1 is a gap between the lower end of the main pole and a lower end of the return pole.
